(19) United States
(12) Patent Application Publication
(10) Pub. No.: US 2008/0309016 A1
(43) Pub. Date: Dec. 18, 2008

(54) SEALING DEVICE

(75) Inventors: Kentaro OZAWA, Fukushima (JP); Takayuki OYAMA, Fukushima (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/132,986

(22) Filed: Jun. 4, 2008

(30) Foreign Application Priority Data
Jun. 15, 2007 (JP) 2007-158634

(51) Int. Cl. F16J 15/50

(52) U.S. Cl. 277/345

(57) ABSTRACT

To prevent falling away of a backup ring (3) from a main lip (12) when uninstalled to a device and prevent inverse assembling, a sealing device is provided with an attaching ring (11), a main lip (12) integrally provided on an inner periphery of the attaching ring, and a backup ring (3) supported to a backup ring support portion (15) formed on an inner periphery of the main lip (12) so as to be positioned at an atmospheric air side than a sliding surface with a shaft, the backup ring support portion (15) and the backup ring (3) are fitted to each other with their fitting surfaces (15a, 31a) which become smaller in diameter relatively toward an outer side in an axial direction, whereby the backup ring (3) is fitted to the backup ring support portion (15) and has directionality in the fitting surfaces (15a, 31a).

### BACKGROUND OF THE INVENTION

1. Field of the Invention

The present invention relates to a sealing device for sealing high-pressure fluid on an outer periphery of a shaft, for example, a piston rod or the like.

2. Description of the Conventional Art

A hydraulic shock absorber of a vehicle is provided with a sealing device for sealing a shaft periphery of a piston rod. FIG. 5 is a one side cross sectional view of a conventional sealing device in an installed state to a hydraulic shock absorber, shown by cutting it along a plane passing through an axis O, FIG. 6 is a one side cross sectional view of the same in an uninstalled and separated state, and FIG. 7 is a partly enlarged cross sectional view.

The conventional sealing device shown in FIG. 5 is provided with an oil seal 101 for sealing working fluid in an inner portion of the hydraulic shock absorber as a sealed subject, a dust seal 102 for preventing dusts and muddy water from making an intrusion from an outer portion, and a backup ring 103. Both the seals 101 and 102 are structured such that metal attaching rings 101a and 102a on their outer peripheries are pinched between a caulked portion 111a at an open end of a cylinder 111 in the hydraulic shock absorber and a rod guide 112 at an inner side of the caulked portion 111a.

The oil seal 101 is structured by integrally forming a main lip 101b slidably brought into close contact with an outer peripheral surface of the piston rod 113 in a state of being directed to an inner side in an axial direction, and an outer peripheral lip 101c for sealing between the cylinder 111 and the rod guide 112 on an attaching ring 101a by a rubber-like elastic material, and the dust seal 102 is structured by integrally forming a dust lip 102b slidably brought into close contact with an outer peripheral surface of the piston rod 113 in a state of being directed to an outer side in the axial direction on an attaching ring 102a by a rubber-like elastic material. The backup ring 103 is made of a synthetic resin, is arranged at an inner periphery of the main lip 101b in the oil seal 101 so as to be positioned at an atmospheric air side than a sliding surface S with the piston rod 113, is retained between the inner periphery of the main lip 101b and an inner peripheral portion of the attaching ring 102a in the dust seal 102, and bears the main lip 101b from the atmospheric air side and the inner peripheral side.

Describing in detail, a backup ring support portion 101d is formed on a base portion at the side of the attaching ring 101a of the main lip 101b in the oil seal 101, as shown in FIGS. 6 and 7, and an outer peripheral portion 103a of the backup ring 103 is loosely fitted to the backup ring support portion 101d, between approximately cylindrical surfaces thereof.

In other words, the sealing device inhibits the working fluid in the inner portion from flowing out to an outer portion of the hydraulic shock absorber on the basis of a close contact of the main lip 101b of the oil seal 101 with an outer peripheral surface of the piston rod 113 with a suitable fastening margin, and the dust seal 102 inhibits a foreign material from making an intrusion into an inner portion of the hydraulic shock absorber from the outer portion, on the basis of a close contact of the dust lip 102b with the outer peripheral surface of the piston rod 113 with a suitable fastening margin. Further, if pressure of the working fluid rises in accordance with a motion of the piston in the inner portion of the hydraulic shock absorber, the oil pressure is applied to the main lip 101b in such a manner as to increase tension force applied to the outer peripheral surface of the piston rod 113, however, since the main lip 101b is borne from the atmospheric air side and the inner peripheral side by the backup ring 103, the tension force of the main lip 101b is effectively inhibited from being increased, and its pressure resistance is maintained (for example, refer to Japanese Unexamined Patent Publication No. 2005-273692, and Japanese Unexamined Patent Publication No. 2005-090569).

However, in accordance with the conventional sealing device, the backup ring support portion 101d formed in an approximately cylindrical surface shape on the base portion of the main lip 101b, and the outer peripheral portion 103a formed in an approximately cylindrical surface shape on the backup ring 103 are loosely fitted with a small gap G, as shown in FIG. 7 in order to increase an installation performance of the backup ring 103. Accordingly, even if the backup ring 103 is once inserted to the backup ring support portion 101d of the main lip 101b, the backup ring 103 easily falls away in the uninstalled state to the hydraulic shock absorber. Further, if the oil seal 101 and the dust seal 102 with which the backup ring 103 is not assembled are installed to the hydraulic shock absorber, the inner peripheral surface of the main lip 101b comes into full contact with the outer peripheral surface of the piston rod 113 on the basis of the pressure increase of the working fluid in the inner portion of the hydraulic shock absorber, whereby there is a problem that the pressure resistance of the main lip 101b is deteriorated as well as the sliding load is significantly increased.

Further, there is a risk that the backup ring 103 is assembled in an inverse direction in the axial direction with respect to the backup ring support portion 101d of the main lip 101b, and it is hard to become aware of the inverse assembly. Further, also in the case that the sealing device is installed to the hydraulic shock absorber in the state mentioned above, the backup ring 103 does not normally bear the main lip 101b. Accordingly, there is a risk that the sliding load of the main lip 101b is increased and the pressure resistance is deteriorated.

### SUMMARY OF THE INVENTION

### Problem to be Solved by the Invention

The present invention is made by taking the above points into consideration, and a technical object of the present invention is to provide a sealing device in which a backup ring can be prevented from falling away from a main lip in an uninstalled state to a device and being assembled inversely.

### Means for Solving the Problem

As a means for effectively solving the technical problem mentioned above, in accordance with the present invention, there is provided a sealing device comprising:

an attaching ring;

a main lip integrally provided on an inner periphery of the attaching ring, and slidably brought into close contact with an outer peripheral surface of a shaft in a state of being directed to an inner side in an axial direction; and

a backup ring which is supported to a backup ring support portion formed on an inner periphery of the main lip so as to be positioned at an atmospheric air side than a sliding surface with the shaft, and bears the main lip from the atmospheric air side and the inner peripheral side,

wherein the backup ring support portion of the main lip and the backup ring are fitted to each other with their fitting surfaces which become smaller in diameter relatively toward an outer side in an axial direction.

In accordance with the structure mentioned above, the backup ring is fitted to the backup ring support portion between their fitting surfaces which become smaller in diameter relatively toward the outer side in the axial direction, by being pressure inserted to the inner periphery of the backup ring support portion formed on the inner periphery of the main lip. Accordingly, the backup ring once fitted is effectively prevented from coming off, and does not easily fall away from the backup ring support portion. Further, since the fitting surface has a directionality, it is impossible to inversely pressure insert and fit the backup ring.

In the sealing device having the structure mentioned above, it is further preferable that an introduction surface which becomes larger in diameter toward an outer side in the axial direction is formed at an outer side in the axial direction than the fitting surface to the backup ring on the inner peripheral surface of the backup ring support portion. In accordance with the structure mentioned above, the introduction surface which becomes larger in diameter toward the outer side in the axial direction is deformed so as to enlarge its diameter by pressing of the backup ring to an inner periphery of the introduction surface at a time of assembling of the backup ring thereto, and the backup ring is snap fitted to the fitting surface at the back thereof and can be easily assembled.

### EFFECT OF THE INVENTION

In accordance with the sealing device on the basis of the present invention, it is possible to effectively prevent the backup ring once fitted to the backup ring support portion, which is formed on the inner periphery of the main lip so as to be positioned at the atmospheric air side than the sliding surface with the shaft, from falling away from the backup ring support portion in the uninstalled state to the device, or prevent the backup ring from being inversely assembled.

### BRIEF EXPLANATION OF DRAWINGS

FIG. 1 is a one side cross sectional view of a sealing device in accordance with the present invention in an installed state to a hydraulic shock absorber, shown by cutting it along a plane passing through an axis O of the sealing device;

FIG. 2 is a one side cross sectional view of the sealing device in accordance with the present invention in an uninstalled and separated state, shown by cutting it along a plane passing through the axis O of the sealing device;

FIG. 3 is a partly enlarged cross sectional view of the sealing device in accordance with the present invention;

FIG. 4 is a partly enlarged cross sectional view showing a case that a backup ring is going to be assembled inversely, in the sealing device in accordance with the present invention;

FIG. 5 is a one side cross sectional view of a conventional sealing device in an installed state to a hydraulic shock absorber, shown by cutting it along a plane passing through an axis O of the sealing device;

FIG. 6 is a one side cross sectional view of the conventional sealing device in an uninstalled and separated state, shown by cutting it along a plane passing through the axis O of the sealing device; and

FIG. 7 is a partly enlarged cross sectional view of the conventional sealing device.

### DETAILED DESCRIPTION OF PREFERRED EMBODIMENT

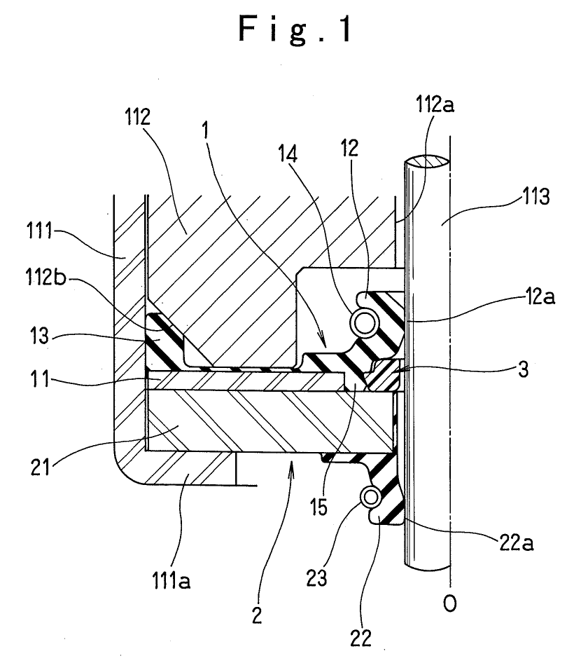

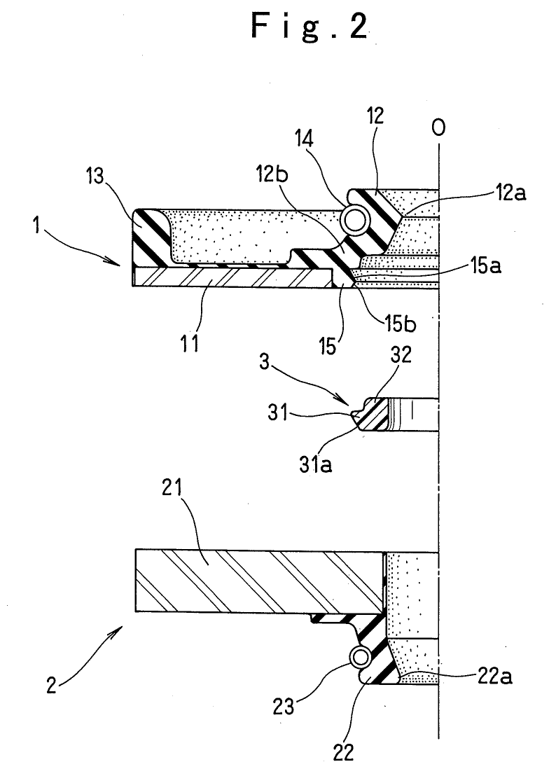

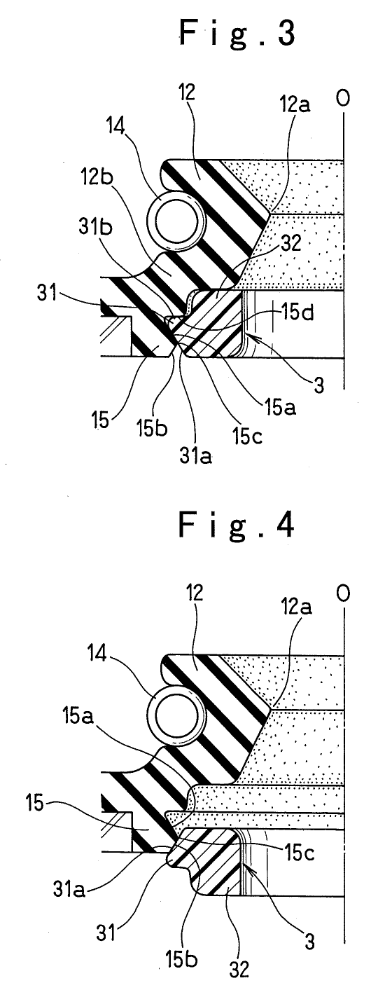

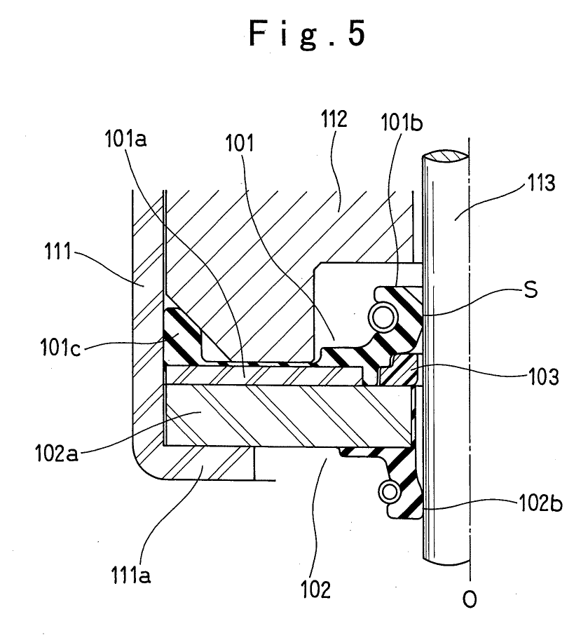

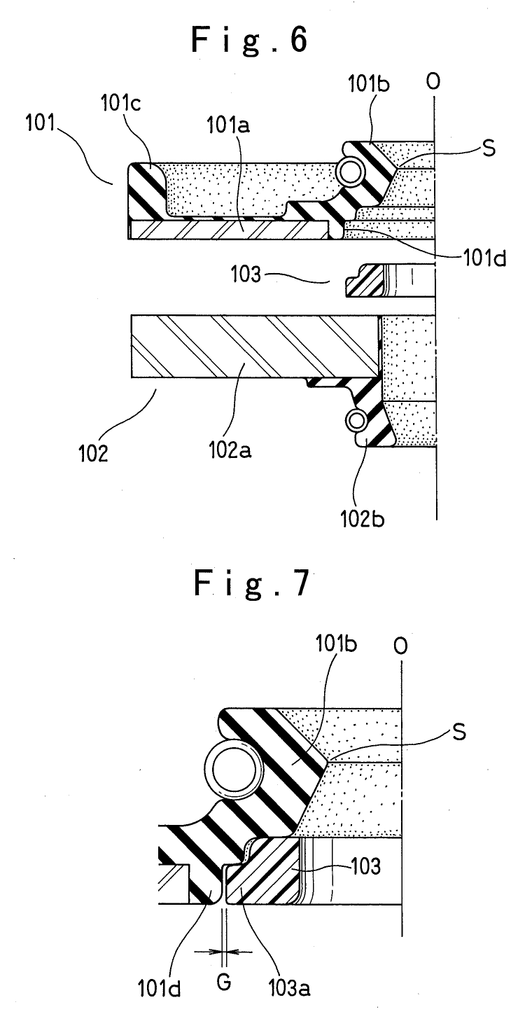

A description will be given in detail below of a preferable embodiment of a sealing device in accordance with the present invention with reference to the accompanying drawings. FIG. 1 is a one side cross sectional view of a sealing device in accordance with the present invention in an installed state to a hydraulic shock absorber, shown by cutting it along a plane passing through an axis O of the sealing device, FIG. 2 is a one side cross sectional view of the same in an uninstalled and separated state, and FIG. 3 is a partly enlarged cross sectional view of the same.

In FIG. 1, reference numeral 111 denotes a cylinder of a hydraulic shock absorber, reference numeral 112 denotes a rod guide provided in an inner periphery near an end portion of the cylinder 111, and reference numeral 113 denotes a piston rod passing through a shaft hole 112a in an inner periphery of the rod guide 112 so as to protrude to an outer portion of the cylinder 111. In this case, the piston rod 113 corresponds to a shaft described later in claim 1.

The sealing device in accordance with the present invention is provided with an oil seal 1 for sealing working fluid in an inner portion of the hydraulic shock absorber as a sealed subject, a dust seal 2 for preventing dusts and muddy water from making an intrusion from an outer portion, and a backup ring 3. Both the seals 1 and 2 are structured such that attaching rings 11 and 21 on their outer peripheries are pinched between a caulked portion 111a at an open end of the cylinder 111 in the hydraulic shock absorber and a rod guide 112 at an inner side thereof.

The oil seal 1 is structured by integrally forming a main lip 12, which extends from an inner peripheral portion of a washer-shaped attaching ring 11 toward an inner side in an axial direction and has a seal edge 12a having a chevron-shaped cross sectional inner periphery slidably brought into close contact with an outer peripheral surface of the piston rod 113, and an outer peripheral lip 13, which is interposed in a compressed state between an inner peripheral surface of the cylinder 111 and an end portion outer peripheral notch surface 112b of the rod guide 112, on the washer-shaped attaching ring 11 manufactured by punching a metal plate, by a rubber-like elastic material. An extension spring 14 for compensating tension force and a fitting characteristic in a diametrical direction is fitly attached to an outer peripheral side of the seal edge 12a of the main lip 12.

The dust seal 2 is structured by integrally forming a dust lip 22, which extends toward an outer side in the axial direction and has a leading end inner peripheral portion 22a slidably brought into close contact with an outer peripheral surface of the piston rod 113, on a washer-shaped attaching ring 21 manufactured by punching a metal plate, by a rubber-like elastic material. An extension spring 23 for compensating tension force and a fitting characteristic in a diametrical direction is fitly attached to an outer peripheral surface near the leading end of the dust lip 22.

A backup ring support portion 15 is formed at an atmospheric air side than the seal edge 12a forming a sliding surface with the piston rod 113 on an inner periphery of the main lip 12 in the oil seal 1, that is, on an inner periphery of a base portion of the main lip 12 adhered to an inner peripheral end of the attaching ring 11, as shown in FIGS. 2 and 3, and an inner peripheral fitting surface 15a of the backup ring support portion 15 is formed in a taper shape which relatively becomes smaller in diameter toward an outer side in the axial direction. Further, an introduction surface 15b formed so as to have a larger diameter toward an outer side in the axial direction, that is, formed in an inverted taper shape to the inner peripheral fitting surface 15a is formed at an outer side in the axial direction than the inner peripheral fitting surface 15a.

The backup ring 3 is made of a synthetic resin which is excellent in an abrasion resistance and has a low friction coefficient, such as a PTFE or the like, has a slightly larger inner diameter than an outer diameter of the piston rod 113, is thus loosely inserted to an outer periphery of the piston rod 113, is arranged in an inner periphery of the main lip 12 in the oil seal 1 so as to be positioned at the atmospheric air side than the seal edge 12a, is fitted to the backup ring support portion 15 with its outer periphery, and is retained between the inner periphery of the main lip 12 and an inner peripheral portion of the attaching ring 21 in the dust seal 2.

Describing in detail, the backup ring 3 has a fitting portion 31 provided with a taper-shaped outer peripheral fitting surface 31a, which can come into close contact with the inner peripheral fitting surface 15a of the backup ring support portion 15 in the oil seal 1, that is, relatively becomes smaller in diameter toward an outer side in the axial direction, and a support protruding portion 32 protruding in the axial direction from an inner peripheral side of the fitting portion 31 and bearing a neck portion 12b between the seal edge 12a in the main lip 12 and the backup ring support portion 15 from an inner peripheral side of the neck portion 12b and the atmospheric air side. Further, a maximum diameter portion of the outer peripheral fitting surface 31a of the backup ring 3 is larger in diameter than a relative minimum diameter portion 15c (refer to FIG. 3) between the inner peripheral fitting surface 15a and the introduction surface 15b which are formed in inverted taper shapes to each other, an outer diameter of the support protruding portion 32 is smaller in diameter than the minimum diameter portion 15c, and, in a state in which the inner peripheral fitting surface 15a of the backup ring support portion 15 comes into close contact with and is fitted to the outer peripheral fitting surface 31a of the backup ring 3, an end surface 31b of the fitting portion 31 directed to the support protruding portion 32 side is brought into collision with an end surface 15d extending in a step shape to an inner peripheral side from an opposite side to the introduction surface 15b in the inner peripheral fitting surface 15a.

In accordance with the sealing device of the present invention structured as mentioned above, the oil seal 1 prevents working fluid in the inner portion of a hydraulic shock absorber from leaking to the atmospheric air side through the shaft periphery of the piston rod 113 by the main lip 12 slidably brought into close contact with the outer peripheral surface of the piston rod 113, and seals between the inner peripheral surface of the cylinder 111 and the rod guide 112 by the outer peripheral lip 13, in the installed state shown in FIG. 1. Further, since the dust lip 22 is slidably brought into close contact with the outer peripheral surface of the piston rod 113, the dust seal 2 prevents dusts and muddy water in the atmospheric air side from making an intrusion into the inner portion of the hydraulic shock absorber through the shaft periphery of the piston rod 113.

Further, if the pressure of working fluid is increased in accordance with a motion of a piston in an inner portion of a hydraulic shock absorber, the hydraulic pressure acts on the main lip 12 in such a manner as to increase tension force applied to the outer peripheral surface of the piston rod 113, however, the main lip 12 is borne by the backup ring 3 from the atmospheric air side and the inner peripheral side. Since the backup ring 3 is made of a synthetic resin having desired rigidity, the increase of the tension force of the main lip 12 is effectively suppressed, and pressure resistance of the main lip 12 is maintained.

In this case, in the sealing device in accordance with the illustrated aspect, the backup ring 3 is previously preassembled in the oil seal 1 in a state before the sealing device is installed to the hydraulic shock absorber. At a time of this preassembly, the backup ring 3 is inserted toward the inner periphery of the backup ring support portion 15 in the oil seal 1 from a separated state shown in FIG. 2, in such a manner that the support protruding portion 32 is placed at the leading side.

In the inserting process of the backup ring 3, the maximum diameter portion of the fitting portion 31 of the backup ring 3 interferes with the introduction surface 15b of the backup ring support portion 15 in the oil seal 1, however, the maximum diameter portion of the fitting portion 31 gets over the minimum diameter portion 15c of the backup ring support portion 15 while forcibly expanding the backup ring support portion 15, by further inserting the backup ring 3. At this time point, the outer peripheral fitting surface 31a of the fitting portion 31 of the backup ring 3 is brought into close contact with and fitted to the inner peripheral fitting surface 15a of the backup ring support portion 15 in a moment of time, and the end surface 31b of the fitting portion 31 is brought into collision with the end surface 15d of the backup ring support portion 15. In other words, since it is possible to get such a response as to fit in a snap action manner at a time when the backup ring 3 is assembled in the backup ring support portion 15 of the oil seal 1, it is possible to easily determine that the backup ring 3 is preassembled in a normal state.

Accordingly, since the backup ring 3 does not fall away once the backup ring 3 is preassembled in the backup ring support portion 15 formed in the inner periphery of the main lip 12 in the oil seal 1 so as to be positioned at the atmospheric air side than the sliding surface in accordance with the fitting, it is possible to prevent the oil seal 1 and the dust seal 2 from being installed to the hydraulic shock absorber in a state in which the backup ring 3 lacks.

FIG. 4 is a partly enlarged cross sectional view showing a case that the backup ring 3 is going to be assembled in an inverted direction in the backup ring support portion 15 of the oil seal 1. In particular, if it is tried to inversely insert the backup ring 3 erroneously as shown in this FIG. 4, the outer peripheral fitting surface 31a of the fitting portion 31 of the backup ring 3 first interferes with the introduction surface 15b of the backup ring support portion 15 in the oil seal 1 in this process. Accordingly, even if the backup ring 3 is further inserted after the interference, the outer peripheral fitting surface 31a neither come into close contact with nor be fitted to the inner peripheral fitting surface 15a of the backup ring support portion 15, because the fitting surfaces 15a and 31a have the taper surfaces in the inverse direction to each other. Therefore, the backup ring 3 lifts up from the backup ring support portion 15 on the basis of an insertion resistance which is increased by the expansion of the backup ring support portion 15, and it is possible to easily recognize the inversion.

Accordingly, it is possible to prevent the oil seal 1 and the dust seal 2 from being installed to the hydraulic shock absorber in the state in which the backup ring 3 is inversely assembled in the oil seal 1.

What is claimed is:

1. A sealing device comprising:
an attaching ring;
a main lip integrally provided on an inner periphery of the attaching ring, and slidably brought into close contact with an outer peripheral surface of a shaft in a state of being directed to an inner side in an axial direction; and
a backup ring which is supported to a backup ring support portion formed on an inner periphery of said main lip so as to be positioned at an atmospheric air side than a sliding surface with said shaft, and bears said main lip from the atmospheric air side and the inner peripheral side,
wherein the backup ring support portion of said main lip and an outer peripheral portion of said backup ring are fitted to each other with their fitting surfaces which become smaller in diameter relatively toward an outer side in an axial direction.

2. A sealing device as claimed in claim 1, wherein an introduction surface, which becomes larger in diameter toward an outer side in the axial direction, is formed at an outer side in the axial direction than the fitting surface to the backup ring on the inner peripheral surface of the backup ring support portion.
